(19) United States
(12) Patent Application Publication
(10) Pub. No.: US 2018/0328102 A1
(43) Pub. Date: Nov. 15, 2018

(54) COMBINATION DYNAMIC AND SWITCHABLE WINDOW GLASS UNITS

(71) Applicant: Harlan J. Byker, West Olive, MI (US)

(72) Inventor: Harlan J. Byker, West Olive, MI (US)

(73) Assignee: Pleotint, L.L.C., Jenison, MI (US)

(21) Appl. No.: 15/977,214

(22) Filed: May 11, 2018

Related U.S. Application Data
(60) Provisional application No. 62/505,317, filed on May 12, 2017.

(51) Int. Cl. E06B 3/67; B32B 7/12; B32B 17/10; G02F 1/1343; G02F 1/1333; G02F 1/1339; E06B 9/24

(52) U.S. Cl. CPC E06B 3/6715; B32B 7/12; B32B 17/10055; B32B 17/10504; B32B 17/10477; E06B 2009/2464; G02F 1/133305; G02F 1/1339; E06B 9/24; B32B 2307/304; G02F 2001/133302; G02F 1/13439

(57) ABSTRACT

An improved insulated glass unit is disclosed having an outboard pane with one or more than one dynamic layer, which may be a thermochromic layer, and an inboard pane with one or more than one switchable layer, which may be a liquid crystal containing layer. Between the panes is a gas space that is sealed around the perimeter of the unit. Preferably, at least one low-e coating is placed in contact with the sealed gas space. The simplicity of manufacture of the window unit and durability of the switchable component is dramatically increased by this invention.

### CROSS-REFERENCE TO RELATED APPLICATIONS

This application claims the benefit of the filing date of U.S. Provisional Application No. 62/505,317, which was filed on May 12, 2017. The contents of U.S. Application No. 62/505,317 are incorporated by reference in their entirety as part of this application.

### BACKGROUND

Window glass units may incorporate dynamic window technologies such as thermochromic, electrochromic, photo-electrochromic, thermotropic, electrotropic or suspended particles that allow for variable transmission of light through the window. Dynamic window technologies typically change transmission of windows with little or no change in light scattering. Dynamic windows provide desirable variable solar heat gain and variable daylighting control throughout changing incident sunlight conditions. Preferred are windows with sunlight responsive thermochromic materials and systems.

### SUMMARY OF THE INVENTION

Window glass units may incorporate switchable technologies that allow the light transmitted to be more scattered or less scattered. Switchable technologies generally involve thermotropic or electrotropic materials and systems. Preferred switchable technologies involve liquid crystal systems including polymer dispersed liquid crystal layers, polymer stabilized cholesteric texture layers and bi-stable, ion doped semetic liquid crystal layers. Windows with switchable technologies are useful to provide privacy but generally have little ability to impact solar heat gain. Switchable windows often require a voltage to be applied across the light scattering layer and are generally used for privacy windows on the interior of a structure. The present invention provides for use of switchable windows in a system that provides exceptional durability for switchable window technology in exterior window applications.

In another aspect the inventions involve simplified and light weight constructions for dynamic and switchable window glass units especially by eliminating some of the layers normally present in such units.

Thus, advantageous window glass units that combine dynamic and switchable technologies have been devised. In the inventions, a dynamic layer is placed between the sun and a switchable liquid crystal comprising layer to minimize direct sunlight exposure of the switchable layer especially minimizing exposure of the switchable layer to ultraviolet light from the sun. The dynamic layer also attenuates visible light thus preventing intense visible light from reaching the switchable layer. At the same time a low-e coating is provided between the dynamic sunlight absorbing layer and a switchable liquid crystal comprising layer. This is very effective in preventing heat buildup in the switchable layer either by reflecting infrared light or by poorly emitting infrared light. Thus, durability of the switchable layer component of the window glass unit is dramatically increased by blocking ultraviolet, intense visible and infrared light all of which could cause degradation by heating the switchable layer too hot and/or by photodegradation. Thus, the current invention improves the longevity of the switchable layer especially in an exterior window application.

The preferred embodiment is an outboard pane with one or more than one dynamic layer and an inboard pane with one or more than one switchable layer. Between the panes is a gas space that is sealed around the perimeter of the double pane window glass unit which is also known as an insulated glass unit. Preferably, at least one low-e coating is placed in contact with the sealed gas space.

A more preferred embodiment involves one or more than one thermochromic layer as part of an outboard pane and a liquid crystal containing switchable layer as part of an inboard pane. A low-e coating is generally provided on at least one of the panes in contact with the gas space between the panes. The durability of the switchable component is dramatically increased by this invention.

### BRIEF DESCRIPTION OF THE DRAWINGS

FIG. 1 is a partial cross-sectional view of an IGU according to a first embodiment;

FIG. 2 is a partial cross-sectional view of an IGU according to a second embodiment;

FIG. 3 is a partial cross-sectional view of an IGU according to a third embodiment;

FIG. 4a is a partial cross-sectional view of an IGU according to a fourth embodiment;

FIG. 4b is a partial cross-sectional view of an IGU according to a variation on the fourth embodiment;

FIG. 5 is a partial cross-sectional view of an IGU according to a fifth embodiment;

FIG. 6a is a partial cross-sectional view of a first embodiment of the thermochromic layer of the invention;

FIG. 6b is a partial cross-sectional view of a second embodiment of the thermochromic layer of the invention;

FIG. 6c is a partial cross-sectional view of a third embodiment of the thermochromic layer of the invention;

FIG. 7 is a partial cross-sectional view of a switchable layer of the invention.

### DETAILED DESCRIPTION

In all the embodiments disclosed below the identified substrates, interlayers, layers and spaces may be in contact with the adjacent substrates, interlayers, layers or spaces.

Embodiment 1 of the invention is an insulated glass unit for a window comprising in the following order:

1. a first glass substrate

2. a thermochromic layer

3. a second glass substrate

4. an optional low-e coating

5. a gas space

6. an optional low-e coating

7. a third glass substrate

8. a first adhesive layer

9. a first plastic substrate

10. a first transparent conductive layer

11. an optional dielectric layer

12. a liquid crystal comprising layer

13. an optional dielectric layer

14. a second transparent conductive layer

15. a second plastic substrate

16. a second adhesive layer

17. a fourth glass substrate

wherein the first and second glass substrates are independently selected preferably from chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the third and fourth glass substrates are independently selected preferably from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the thermochromic layer comprises one or more than one layer comprising thermochromic material(s) and/or system(s) and a separator if there is more than one thermochromic layer wherein the separator for thermochromic layers preferably is selected from a layer of polyester, polyethylene terephthalate, polyethylene naphthalate, acrylic, glass and cyclic olefin polymers or copolymers and wherein the gas space preferably comprises air, nitrogen, argon, krypton, sulfur hexafluoride, carbon dioxide or combinations thereof and wherein the optional low-e coating is generally a series of coatings and preferably comprises a transparent conductive metal oxide layer and/or thin layers of silver or silver alloys and wherein the first and second adhesive layers or interlayers are independently selected preferably from polyvinylbutyral, thermoplastic polyurethane, ethylene vinyl acetate, ionomers and ionomers comprising metal ions, an acrylic containing layer and a silicone containing layer and wherein the first and second plastic substrates are independently selected preferably from layers of polyester, polyethylene terephthalate, polyethylene naphthalate, acrylic and cyclic olefin polymers or copolymers and wherein the first and second transparent conductive layers are independently selected preferably from one layer or a stack of layers which include fluorine doped tin oxide, fluorine doped zinc oxide, tin doped indium oxide (ITO), aluminum doped zinc oxide, silver and alloys of silver that are optionally color suppressed or color compensated and wherein the optional dielectric layers are thin layers of high dielectric strength materials like insulating metal oxides or polymers and the unit comprises at least one of the optional dielectric layers and wherein the liquid crystal comprising layer preferably comprises cholesteric and/or nematic liquid crystals in droplets or small domains within a polymer matrix or network or dynamic scattering liquid crystals or semectic liquid crystals or siloxane containing semectic liquid crystals or a combination of any of these liquid crystal types.

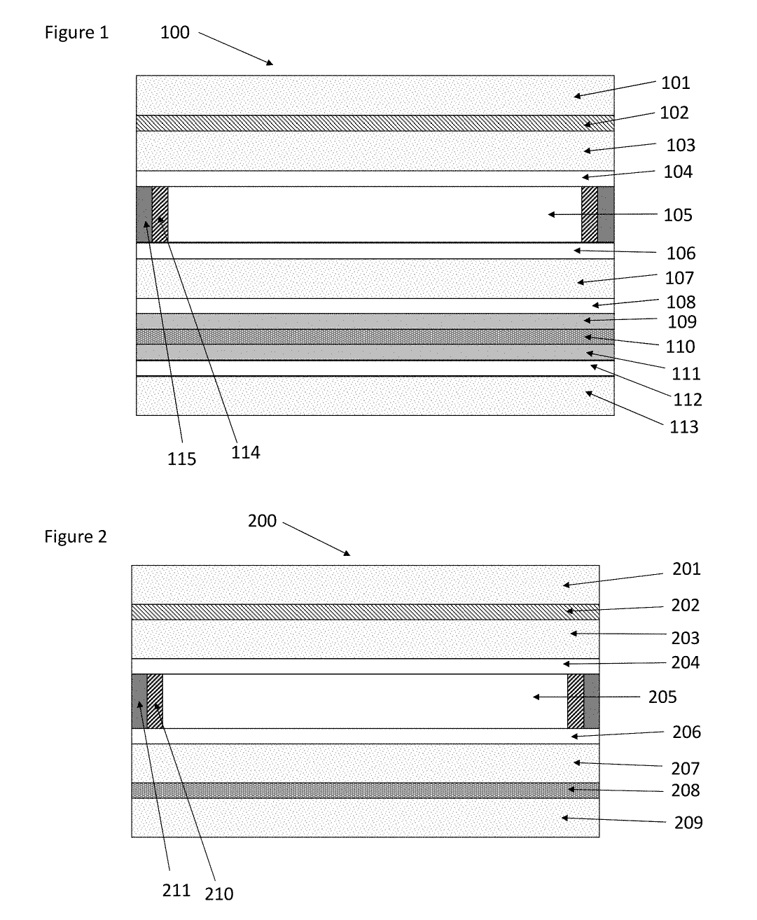

FIG. 1 shows a partial cross sectional view of an IGU 100 comprising a first glass substrate 101; a thermochromic layer 102; a second glass substrate 103; a first low-e coating 104; a gas space 105; a second low-e coating 106; a third glass substrate 107; a first adhesive layer 108; a first plastic substrate 109; a switchable layer 110; a second plastic substrate 111; a second adhesive layer 112; a fourth glass substrate 113; a spacer and primary seal 114 and a secondary seal 115. According to this embodiment, the spacer and primary seal 114 and the secondary seal 115 are positioned around the perimeter of the IGU 100 between the second glass substrate 103 and third glass substrate 107 to form a sealed gas space 105.

Embodiment 2 of the invention is an insulated glass unit for a window comprising in the following order:

1. a first glass substrate

2. a thermochromic layer

3. a second glass substrate

4. an optional low-e coating

5. a gas space

6. an optional low-e coating

7. a third glass substrate

8. a first transparent conductive layer

9. an optional dielectric layer

10. a liquid crystal comprising layer

11. an optional dielectric layer

12. a second transparent conductive layer

13. a fourth glass substrate

wherein the first and second glass substrates are independently selected preferably from chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the third and fourth glass substrates are independently selected preferably from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the thermochromic layer comprises one or more than one layer comprising thermochromic material(s) and/or system(s) and a separator if there is more than one thermochromic layer wherein the separator for thermochromic layers preferably is selected from a layer of polyester, polyethylene terephthalate, polyethylene naphthalate, acrylic, glass and cyclic olefin polymers or copolymers and wherein the gas space preferably comprises air, nitrogen, argon, krypton, sulfur hexafluoride, carbon dioxide or combinations thereof and wherein the optional low-e coating is generally a series of coatings and preferably comprises a transparent conductive metal oxide layer and/or thin layers of silver or silver alloys and wherein the first and second transparent conductive layers are independently selected preferably from one layer or a stack of layers which include fluorine doped tin oxide, fluorine doped zinc oxide, tin doped indium oxide (ITO), aluminum doped zinc oxide, silver and alloys of silver that are optionally color suppressed or color compensated or color compensated and wherein the optional dielectric layers are thin layers of high dielectric strength materials like insulating metal oxides or polymers and the unit comprises at least one of the optional dielectric layers and wherein the liquid crystal comprising layer preferably comprises cholesteric and/or nematic liquid crystals in droplets or small domains within a polymer matrix or network or dynamic scattering liquid crystals or semectic liquid crystals or siloxane containing semectic liquid crystals or a combination of any of these liquid crystal types.

FIG. 2 shows a partial cross sectional view of an IGU 200 comprising a first glass substrate 201; a thermochromic layer 202; a second glass substrate 203; a first low-e coating 204; a gas space 205; a second low-e coating 206; a third glass substrate 207; a switchable layer 208; a fourth glass substrate 209; a spacer and primary seal 210 and a secondary seal 211. According to this embodiment, the spacer and primary seal 210 and the secondary seal 211 are positioned around the perimeter of the IGU 200 between the second glass substrate 203 and third glass substrate 207 to form a sealed gas space 205.

Embodiment 3 of the invention is an insulated glass unit for a window comprising in the following order:

1. a first glass substrate

2. a thermochromic layer

3. a second glass substrate

4. an optional low-e coating

5. a gas space

6. an optional low-e coating

7. a first plastic substrate

8. a first transparent conductor layer

9. an optional dielectric layer

10. a liquid crystal comprising layer

11. an optional dielectric layer

12. a second transparent conductor layer

13. a second plastic substrate

14. an adhesive layer

15. a third glass substrate

wherein the first and second glass substrates are independently selected preferably from chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the third glass substrate is preferably selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the thermochromic layer comprises one or more than one layer comprising thermochromic material(s) and/or system(s) and a separator if there is more than one thermochromic layer wherein the separator for thermochromic layers preferably is selected from a layer of polyester, polyethylene terephthalate, polyethylene naphthalate, acrylic, glass and cyclic olefin polymers or copolymers and wherein the gas space preferably comprises air, nitrogen, argon, krypton, sulfur hexafluoride, carbon dioxide or combinations thereof and wherein the optional low-e coating is generally a series of coatings and preferably comprises a transparent conductive metal oxide layer and/or thin layers of silver or silver alloys and wherein the first and second plastic substrates are independently selected preferably from layers of polyester, polyethylene terephthalate, polyethylene naphthalate, acrylic and cyclic olefin polymers or copolymers and wherein the first and second transparent conductive layers are independently selected preferably from one layer or a stack of layers which include fluorine doped tin oxide, fluorine doped zinc oxide, tin doped indium oxide (ITO), aluminum doped zinc oxide, silver and alloys of silver that are optionally color suppressed or color compensated and wherein the optional dielectric layers are thin layers of high dielectric strength materials like insulating metal oxides or polymers and the unit comprises at least one of the optional dielectric layers and wherein the liquid crystal comprising layer preferably comprises cholesteric and/or nematic liquid crystals in droplets or small domains within a polymer matrix or network or dynamic scattering liquid crystals or semectic liquid crystals or siloxane containing semectic liquid crystals or a combination of any of these liquid crystal types and wherein the adhesive layer or interlayer is independently selected from polyvinylbutyral, thermoplastic polyurethane, ethylene vinyl acetate, ionomers and ionomers comprising metal ions, an acrylic containing layer and a silicone containing layer.

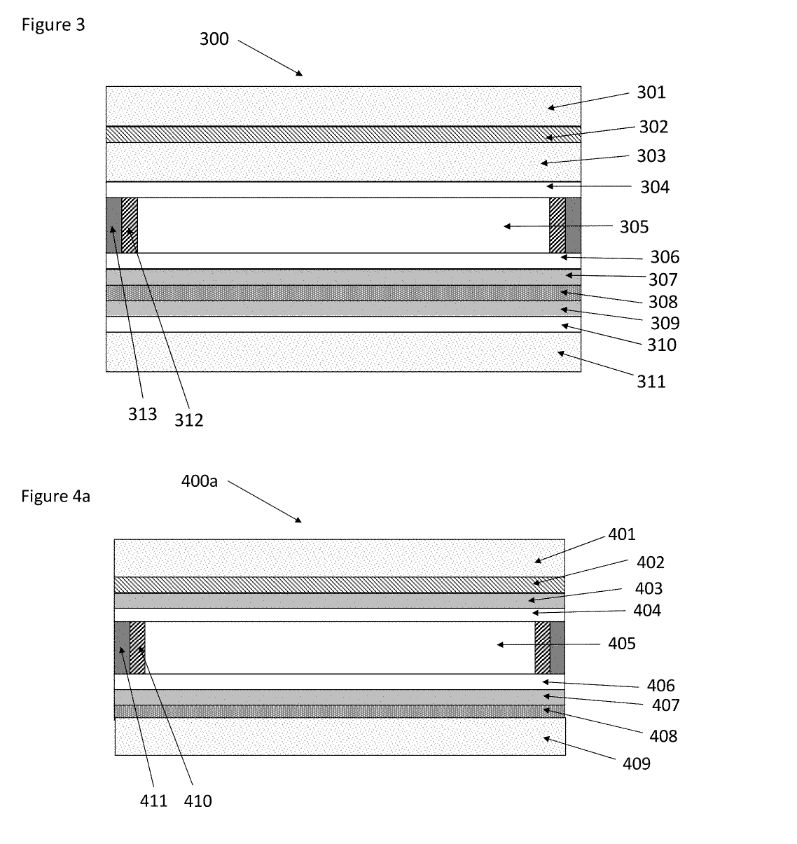

FIG. 3 shows a partial cross sectional view of an IGU 300 comprising a first glass substrate 301; a thermochromic layer 302; a second glass substrate 303; a first low-e coating 304; a gas space 305; a second low-e coating 306; a first plastic substrate 307; a switchable layer 308; a second plastic substrate 309; an adhesive layer 310; a third glass substrate 311; a spacer and primary seal 312 and a secondary seal 313. According to this embodiment, the spacer and primary seal 312 and the secondary seal 313 are positioned around the perimeter of the IGU 300 between the second glass substrate 203 and first plastic substrate 307 to form a sealed gas space 305.

Embodiment 4 of the invention is an insulated glass unit for a window comprising in the following order:

1. a first glass substrate

2. a thermochromic layer

3. a first plastic substrate

4. an optional low-e coating

5. a gas space

6. an optional low-e coating

7. a second plastic substrate

8. a first transparent conductive layer

9. an optional dielectric layer

10. a liquid crystal comprising layer

11. an optional dielectric layer

12. a second transparent conductive layer

13. a second glass substrate

wherein the first glass substrate is preferably selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the second glass substrate is preferably selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the thermochromic layer comprises one or more than one layer comprising thermochromic material(s) and/or system(s) and a separator if there is more than one thermochromic layer wherein the separator for thermochromic layers preferably is selected from a layer of polyester, polyethylene terephthalate, polyethylene naphthalate, acrylic, glass and cyclic olefin polymers or copolymers and wherein the gas space preferably comprises air, nitrogen, argon, krypton, sulfur hexafluoride, carbon dioxide or combinations thereof and wherein the optional low-e coating is generally a series of coatings and preferably comprises a transparent conductive metal oxide layer and/or thin layers of silver or silver alloys and wherein the first and second plastic substrates are independently selected preferably from layers of polyester, polyethylene terephthalate, polyethylene naphthalate, acrylic and cyclic olefin polymers or copolymers and wherein the first and second transparent conductive layers are independently selected preferably from one layer or a stack of layers which include fluorine doped tin oxide, fluorine doped zinc oxide, tin doped indium oxide (ITO), aluminum doped zinc oxide, silver and alloys of silver that are optionally color suppressed or color compensated and wherein the optional dielectric layers are thin layers of high dielectric strength materials like insulating metal oxides or polymers and the unit comprises at least one of the optional dielectric layers and wherein the liquid crystal comprising layer preferably comprises cholesteric and/or nematic liquid crystals in droplets or small domains within a polymer matrix or network or dynamic scattering liquid crystals or semectic liquid crystals or siloxane containing semectic liquid crystals or a combination of any of these liquid crystal types.

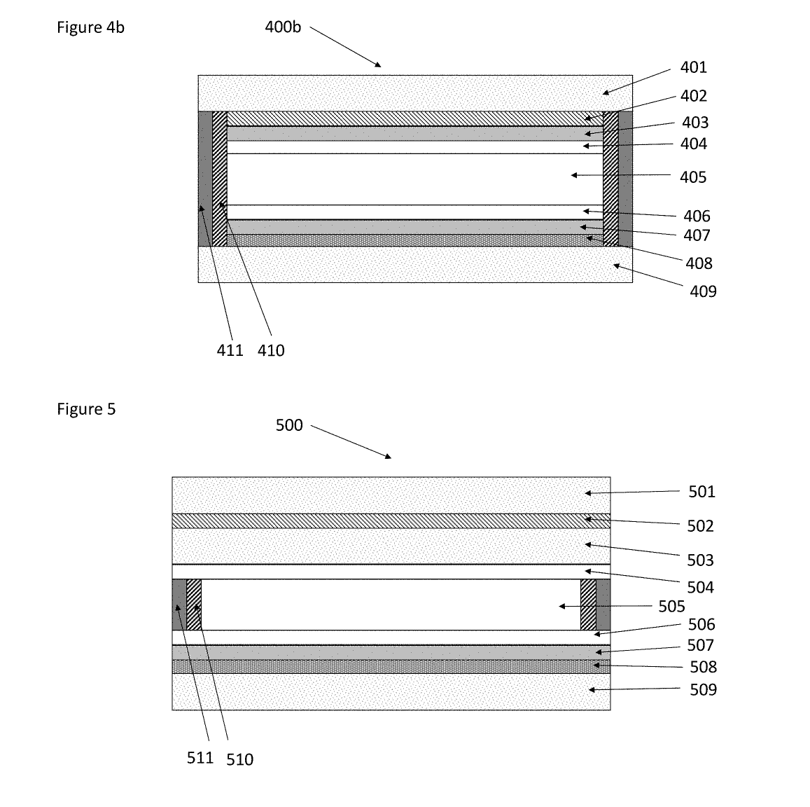

FIG. 4a shows a partial cross sectional view of an IGU 400a comprising a first glass substrate 401; a thermochromic layer 402; a first plastic substrate 403; a first low-e coating 404; a gas space 405; a second low-e coating 406; a second plastic substrate 407; a switchable layer 408; a second glass substrate 409; a spacer and primary seal 410; a secondary seal 411. According to this embodiment, the spacer and primary seal 410 and the secondary seal 411 are positioned around the perimeter of the IGU 400a between the first plastic substrate 403 and second plastic substrate 407 to form a sealed gas space 405.

FIG. 4b shows a partial cross sectional view of an IGU 400b comprising a first glass substrate 401; a thermochromic layer 402; a first plastic substrate 403; a first low-e coating 404; a gas space 405; a second low-e coating 406; a second plastic substrate 407; a switchable layer 408; a second glass substrate 409; a spacer and primary seal 410; a secondary seal 411. The spacer, primary seal and secondary seal surround the lateral sides of, to provide protection for, the thermochromic layer 402 and the switchable layer 408. According to this embodiment, the spacer and primary seal 410 and the secondary seal 411 are positioned around the perimeter of the IGU 400b between the first glass substrate 401 and second glass substrate 409 to form a sealed gas space 405 and the thermochromic layer 402 and the switchable layer 408 are located within the sealed interior space of the IGU 400b. This type of protection may also be provided with this spacer, primary seal and secondary seal configuration for other embodiments.

Embodiment 5 of the invention is an insulated glass unit for a window comprising in the following order:

1. a first glass substrate

2. a thermochromic layer

3. a second glass substrate

4. an optional low-e coating

5. a gas space

6. an optional low-e coating

7. a plastic substrate

8. a first transparent conductive layer

9. an optional dielectric layer

10. a liquid crystal comprising layer

11. an optional dielectric layer

12. a second transparent conductive layer

13. a third glass substrate

wherein the first and second glass substrates are preferably selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the third glass substrate is preferably selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the thermochromic layer comprises one or more than one film comprising thermochromic material(s) and/or system(s) and separator sheet(s) if there is more than one thermochromic film wherein the separator sheet(s) for thermochromic films preferably is selected from a sheet(s) of polyester, polyethylene terephthalate, polyethylene naphthalate, acrylic, glass and cyclic olefin polymers or copolymers and wherein the gas space preferably comprises air, nitrogen, argon, krypton, sulfur hexafluoride, carbon dioxide or combinations thereof and wherein both of the optional low-e coatings is generally a series of coatings and preferably comprises a transparent conductive metal oxide layer and/or thin layers of silver or silver alloys and wherein the plastic substrate is independently selected preferably from layers of polyester, polyethylene terephthalate, polyethylene naphthalate, acrylic and cyclic olefin polymers or copolymers and wherein the first and second transparent conductive layers are independently selected preferably from one layer or a stack of layers which include fluorine doped tin oxide, fluorine doped zinc oxide, tin doped indium oxide (ITO), aluminum doped zinc oxide, silver and alloys of silver that are optionally color suppressed or color compensated and wherein the optional dielectric layers are thin layers of high dielectric strength materials like insulating metal oxides or polymers and the unit comprises at least one of the optional dielectric layers and wherein the liquid crystal comprising layer preferably comprises cholesteric and/or nematic liquid crystals in droplets or small domains within a polymer matrix or network or dynamic scattering liquid crystals or semectic liquid crystals or siloxane containing semectic liquid crystals or a combination of any of these liquid crystal types.

FIG. 5 shows a partial cross sectional view of an IGU 500 comprising a first glass substrate 501; a thermochromic layer 502; a second glass substrate 503; a first low-e coating 504; a gas space 505; a second low-e coating 506; a plastic substrate 507; a switchable layer 508; a third glass substrate 509; a spacer and primary seal 510 and a secondary seal 511. According to this embodiment, the spacer and primary seal 510 and the secondary seal 511 are positioned around the perimeter of the IGU 500 between the second glass substrate 503 and first plastic substrate 507 to form a sealed gas space 505.

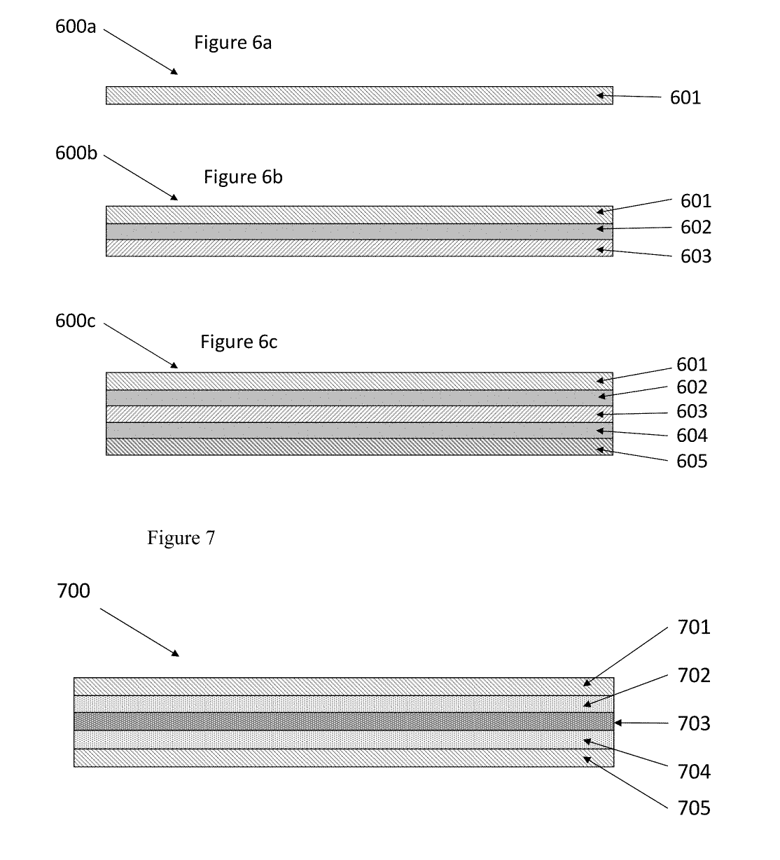

FIG. 6a shows a partial cross sectional view of a thermochromic layer 600a with a thermochromic film 601.

FIG. 6b shows a partial cross sectional view of a thermochromic layer 600b with a first thermochromic film 601, a separator 602, and a second thermochromic film 603.

FIG. 6c shows a partial cross sectional view of a thermochromic layer 600c with a first thermochromic film 601, a first separator 602, a second thermochromic film 603, a second separator 604, and a third thermochromic film 605.

Any of the thermochromic layers 600a, 600b or 600c may be used in any embodiment of the invention.

FIG. 7 shows a partial cross sectional view of a switchable layer 700 with a first transparent conductive layer 701, a first dielectric layer 702, a liquid crystal comprising layer 703, a second dielectric layer 704, and a second transparent conductive layer 705. In the switchable layer there is normally a least one dielectric layer. For the switchable layer almost any switchable liquid crystal layer may be used including those described in “Liquid Crystal Dispersions” (Liquid Crystals Series, Volume 1) by Paul S. Drzaic (Editor) published by World Scientific, ISBN-13: 978-9810217457, which reviews liquid crystal materials and systems, many of which are suitable for use in the switchable layer of the current invention. U.S. Pat. Nos. 8,956,548 and 9,694,740 also disclose liquid crystal materials and systems and the entire contents of these patents are hereby incorporated by reference.

For the thermochromic layers of the invention, U.S. Pat. Nos. 6,084,702; 6,446,402; 7,525,717; 7,538,931; 7,542,196; 7,817,328; 8,018,639; 8,154,788; 8,182,718; 8,431,045; 8,623,243; 9,011,734; 9,128,307; 9,321,251; 9,465,239 and 9,776,379 disclose thermochromic materials, systems, windows and related technologies. The entire contents of these patents are hereby incorporated by reference. Also, published U.S. Patent Applications 20170028686 and 20170361577 disclose materials, systems, windows, window configurations, seals and related technologies. The entire contents of these patent applications are hereby incorporated by reference. Having described the invention in detail and by reference to the various embodiments, it should be understood that modifications and variations thereof are possible without departing from the scope of the claims of the present application.

What is claimed is:

1. An insulated glass unit for a window comprising in the following order:
a first glass substrate;
a thermochromic layer;
a second glass substrate;
an optional low-e coating;
a gas space;
an optional low-e coating;
a third glass substrate;
a first adhesive layer;
a first plastic substrate;
a first transparent conductive layer;
an optional dielectric layer;
a liquid crystal comprising layer;
an optional dielectric layer;
a second transparent conductive layer;
a second plastic substrate;
a second adhesive layer; and
a fourth glass substrate
wherein the first and second glass substrates are independently selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the third and fourth glass substrates are independently selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the gas space comprises air, nitrogen, argon, krypton, sulfur hexafluoride, carbon dioxide or combinations thereof;
wherein the one or more optional low-e coatings comprise a transparent conductive metal oxide layer and/or thin layers of silver or silver alloys;
wherein the first and second adhesive layers are independently selected from polyvinylbutyral, thermoplastic polyurethane, ethylene vinyl acetate, ionomers and ionomers comprising metal ions, an acrylic containing layer and a silicone containing layer;
wherein the first and second plastic substrates are independently selected from layers of polyester, polyethylene terephthalate, polyethylene naphthalate, acrylic and cyclic olefin polymers or copolymers;
wherein the first and second transparent conductive layers are independently selected from one layer or a stack of layers selected from the group consisting of fluorine doped tin oxide, fluorine doped zinc oxide, tin doped indium oxide (ITO), aluminum doped zinc oxide, silver and alloys of silver that are optionally color suppressed or color compensated; and
wherein the liquid crystal comprising layer comprises cholesteric and/or nematic liquid crystals in droplets or small domains within a polymer matrix or network, dynamic scattering liquid crystals, semectic liquid crystals, siloxane containing semectic liquid crystals, or a combination of any of these liquid crystal types.

2. The insulated glass unit of claim 1, wherein the unit comprises at least one of the optional dielectric layers.

3. The insulated glass unit of claim 1, wherein the thermochromic layer comprises a first layer of thermochromic material, a second layer of thermochromic material, and a separator that separates said first layer of thermochromic material from said second layer of thermochromic material, and wherein the separator is selected from a layer of polyester, polyethylene terephthalate, polyethylene naphthalate, acrylic, glass, cyclic olefin polymers or copolymers, or combinations thereof.

4. The insulated glass unit of claim 1 further comprising a spacer, a primary seal, and a secondary seal located around a perimeter of the insulated glass unit to form a sealed interior space.

5. The insulated glass unit of claim 4, wherein one or both of the thermochromic layer and the liquid crystal comprising layer are located in the sealed interior space for protection.

6. An insulated glass unit for a window comprising in the following order:
a first glass substrate;
a thermochromic layer;
a second glass substrate;
an optional low-e coating;
a gas space;
an optional low-e coating;
a third glass substrate;
a first transparent conductive layer;
an optional dielectric layer;
a liquid crystal comprising layer;
an optional dielectric layer;
a second transparent conductive layer; and
a fourth glass substrate;
wherein the first and second glass substrates are independently selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the third and fourth glass substrates are independently selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the gas space comprises air, nitrogen, argon, krypton, sulfur hexafluoride, carbon dioxide or combinations thereof;
wherein the one or more optional low-e coatings comprise a transparent conductive metal oxide layer and/or thin layers of silver or silver alloys;
wherein the first and second transparent conductive layers are independently selected from one layer or a stack of layers selected from the group consisting of fluorine doped tin oxide, fluorine doped zinc oxide, tin doped indium oxide (ITO), aluminum doped zinc oxide, silver and alloys of silver that are optionally color suppressed or color compensated; and
wherein the liquid crystal comprising layer comprises cholesteric and/or nematic liquid crystals in droplets or small domains within a polymer matrix or network, dynamic scattering liquid crystals, semectic liquid crystals, siloxane containing semectic liquid crystals, or a combination of any of these liquid crystal types.

7. The insulated glass unit of claim 6, wherein the thermochromic layer comprises a first layer of thermochromic material, a second layer of thermochromic material, and a separator that separates said first layer of thermochromic material from said second layer of thermochromic material, and wherein the separator is selected from a layer of polyester, polyethylene terephthalate, polyethylene naphthalate, acrylic, glass, cyclic olefin polymers or copolymers, or combinations thereof.

8. The insulated glass unit of claim 6 further comprising a spacer, a primary seal, and a secondary seal located around a perimeter of the insulated glass unit to form a sealed interior space.

9. The insulated glass unit of claim 8, wherein one or both of the thermochromic layer and the liquid crystal comprising layer are located in the sealed interior space for protection.

10. An insulated glass unit for a window comprising in the following order:
a first glass substrate;
a thermochromic layer;
a second glass substrate;
an optional low-e coating;
a gas space;
an optional low-e coating;
a first plastic substrate;
a first transparent conductor layer;
an optional dielectric layer;
a liquid crystal comprising layer;
an optional dielectric layer;
a second transparent conductor layer;
a second plastic substrate;
an adhesive layer; and
a third glass substrate;
wherein the first and second glass substrates are independently selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the third glass substrate is selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the gas space comprises air, nitrogen, argon, krypton, sulfur hexafluoride, carbon dioxide or combinations thereof;
wherein the one or more optional low-e coatings comprise a transparent conductive metal oxide layer and/or thin layers of silver or silver alloys;
wherein the first and second plastic substrates are selected from layers of polyester, polyethylene terephthalate, polyethylene naphthalate, acrylic and cyclic olefin polymers or copolymers;
wherein the first and second transparent conductive layers are independently selected from one layer or a stack of layers selected from the group consisting of fluorine doped tin oxide, fluorine doped zinc oxide, tin doped indium oxide (ITO), aluminum doped zinc oxide, silver and alloys of silver that are optionally color suppressed or color compensated;
wherein the liquid crystal comprising layer comprises cholesteric and/or nematic liquid crystals in droplets or small domains within a polymer matrix or network, dynamic scattering liquid crystals, semectic liquid crystals, siloxane containing semectic liquid crystals, or a combination of any of these liquid crystal types; and
wherein the adhesive layer is selected from polyvinylbutyral, thermoplastic polyurethane, ethylene vinyl acetate, ionomers and ionomers comprising metal ions, an acrylic containing layer, and a silicone containing layer.

11. The insulated glass unit of claim 10, wherein the unit comprises at least one of the optional dielectric layers.

12. The insulated glass unit of claim 10, wherein the thermochromic layer comprises a first layer of thermochromic material, a second layer of thermochromic material, and a separator that separates said first layer of thermochromic material from said second layer of thermochromic material, and wherein the separator is selected from a layer of polyester, polyethylene terephthalate, polyethylene naphthalate, acrylic, glass, cyclic olefin polymers or copolymers, or combinations thereof.

13. The insulated glass unit of claim 10 further comprising a spacer, a primary seal, and a secondary seal located around a perimeter of the insulated glass unit to form a sealed interior space.

14. The insulated glass unit of claim 13, wherein one or both of the thermochromic layer and the liquid crystal comprising layer are located in the sealed interior space for protection.

15. An insulated glass unit for a window comprising in the following order:
a first glass substrate;
a thermochromic layer;
a first plastic substrate;
an optional low-e coating;
a gas space;
an optional low-e coating;
a second plastic substrate;
a first transparent conductive layer;
an optional dielectric layer;
a liquid crystal comprising layer;
an optional dielectric layer;
a second transparent conductive layer; and
a second glass substrate;
wherein the first glass substrate is selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the second glass substrate is selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the gas space comprises air, nitrogen, argon, krypton, sulfur hexafluoride, carbon dioxide or combinations thereof;
wherein the one or more optional low-e coatings comprise a transparent conductive metal oxide layer and/or thin layers of silver or silver alloys;
wherein the first and second plastic substrates are independently selected from layers of polyester, polyethylene terephthalate, polyethylene naphthalate, acrylic and cyclic olefin polymers or copolymers;
wherein the first and second transparent conductive layers are independently selected from one layer or a stack of layers selected from the group consisting of fluorine doped tin oxide, fluorine doped zinc oxide, tin doped indium oxide (ITO), aluminum doped zinc oxide, silver and alloys of silver that are optionally color suppressed or color compensated; and
wherein the liquid crystal comprising layer comprises cholesteric and/or nematic liquid crystals in droplets or small domains within a polymer matrix or network, dynamic scattering liquid crystals, semectic liquid crystals, siloxane containing semectic liquid crystals, or a combination of any of these liquid crystal types.

16. The insulated glass unit of claim 15, wherein the unit comprises at least one of the optional dielectric layers.

17. The insulated glass unit of claim 15, wherein the thermochromic layer comprises a first layer of thermochromic material, a second layer of thermochromic material, and a separator that separates said first layer of thermochromic material from said second layer of thermochromic material, and wherein the separator is selected from a layer of polyester, polyethylene terephthalate, polyethylene naphthalate, acrylic, glass, cyclic olefin polymers or copolymers, or combinations thereof.

18. The insulated glass unit of claim 15 further comprising a spacer, a primary seal, and a secondary seal located around a perimeter of the insulated glass unit to form a sealed interior space.

19. The insulated glass unit of claim 18, wherein one or both of the thermochromic layer and the liquid crystal comprising layer are located in the sealed interior space for protection.

20. An insulated glass unit for a window comprising in the following order:
a first glass substrate;
a thermochromic layer;
a second glass substrate;
an optional low-e coating;
a gas space;
an optional low-e coating;
a plastic substrate;
a first transparent conductive layer;
an optional dielectric layer;
a liquid crystal comprising layer;
an optional dielectric layer;
a second transparent conductive layer; and
a third glass substrate;
wherein the first and second glass substrates are independently selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the third glass substrate is selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass;
wherein the gas space comprises air, nitrogen, argon, krypton, sulfur hexafluoride, carbon dioxide or combinations thereof;
wherein the one or more optional low-e coatings comprise a transparent conductive metal oxide layer and/or thin layers of silver or silver alloys;
wherein the plastic substrate is selected from layers of polyester, polyethylene terephthalate, polyethylene naphthalate, acrylic and cyclic olefin polymers or copolymers;
wherein the first and second transparent conductive layers are independently selected preferably from one layer or a stack of layers selected from the group consisting of fluorine doped tin oxide, fluorine doped zinc oxide, tin doped indium oxide (ITO), aluminum doped zinc oxide, silver and alloys of silver that are optionally color suppressed or color compensated; and
wherein the liquid crystal comprising layer comprises cholesteric and/or nematic liquid crystals in droplets or small domains within a polymer matrix or network, dynamic scattering liquid crystals, semectic liquid crystals, siloxane containing semectic liquid crystals, or a combination of any of these liquid crystal types.

21. The insulated glass unit of claim 20, wherein the unit comprises at least one of the optional dielectric layers.

22. The insulated glass unit of claim 20, wherein the thermochromic layer comprises a first layer of thermochromic material, a second layer of thermochromic material, and a separator that separates said first layer of thermochromic material from said second layer of thermochromic material, and wherein the separator is selected from a layer of polyester, polyethylene terephthalate, polyethylene naphthalate, acrylic, glass, cyclic olefin polymers or copolymers, or combinations thereof.

23. The insulated glass unit of claim 20 further comprising a spacer, a primary seal, and a secondary seal located around a perimeter of the insulated glass unit to form a sealed interior space.

24. The insulated glass unit of claim 23, wherein one or both of the thermochromic layer and the liquid crystal comprising layer are located in the sealed interior space for protection.
